(19) United States
(12) Patent Application Publication
(10) Pub. No.: US 2026/0277937 A1
(43) Pub. Date: Sep. 17, 2026

(54) METHODS FOR AUTOMATED KEY-VALUE TAGGING FOR VISIBILITY IN PLATFORM-AS-A-SERVICE ENVIRONMENTS AND DEVICES THEREOF

(71) Applicant: RapDev LLC, Boston, MA (US)

(72) Inventors: Jonathan James GIARA, Dorchester, MA (US); Matthew MORRIS, Brentwood, TN (US)

(21) Appl. No.: 19/078,367

(22) Filed: Mar. 13, 2025

(51) Int. Cl. G06F 16/28

(52) U.S. Cl. CPC G06F 16/287

(57) ABSTRACT

Methods, non-transitory computer readable media, and platform-as-a-service (PaaS) server devices are disclosed that generate and output for display a tag generation interface in response to a request received for a new tag definition. The request is received via communication networks including an enterprise network associated with an enterprise. The new tag definition received from an enterprise user via the tag generation interface and the user device is obtained and stored. The new tag definition includes an indication of a table, a tag key, and a tag value population method. The new tag definition is applied against the table of a configuration management database (CMDB) to identify configuration items. The CMDB is associated with a platform instance associated with the enterprise. Entries corresponding to the configuration items are updated in a tag store to include the tag key and a tag value determined based on the tag value population method.

### FIELD

This technology generally relates to managing information technology (IT) infrastructure and, more particularly, to methods and devices for automated key-value tagging for visibility in Platform-as-a-Service (PaaS) environments.

### BACKGROUND

Applications and services are increasingly developed and delivered using cloud-based platforms hosted by Platform-as-a-Service (PaaS) providers. PaaS providers deliver software tools over the Internet, which are hosted on their own hardware infrastructure. The resources of the provided platforms can facilitate efficient application development and deployment in order to shorten the software development lifecycle, provide improved visibility into production environments, and reduce service costs and downtime, among other advantages. However, organizations of all sizes still leverage on-prem, third-party managed, or hybrid architectures to develop and deliver applications and services. This variation in environment hosting decisions can lead to gaps in the kind of data available for each device.

In one example, ServiceNow, Inc. of Santa Clara, CA is a PaaS provider that hosts software and hardware environments to enable enterprises to gain visibility across infrastructure and application services, maintain service health, and optimize cloud service delivery, among other functions. The ServiceNow™ platform provides a configuration management database (CMDB) that brings together formerly siloed data across an enterprise that is required to run information technology (IT) infrastructure and services in order to provide IT operations users improved insight with respect to all the IT resources in the enterprise. Thus, the CMDB contains information about an organization's hardware and software assets, as well as the relationships and dependencies between those assets associated with particular application services.

When a tag-based application service is created, a group of tags (i.e., key/value pairs) are designated for the service. Tag-based application service mapping is an efficient and useful way to map cloud and containerized applications and associated IT infrastructure in PaaS environments to provide visualizations and facilitate insights. With tag-based mapping, there is no need for additional applicative credentials or to create custom patterns in order to map application services, which is commonly the case when using traditional top-down service mapping.

Instead, with respect to the ServiceNow™ platform, for example, discovery methods and service graph connectors are configured to bring configuration items (CIs) into a CMDB along with any tags, if established for the target resources associated with the CIs. A service graph connector in the ServiceNow™ platform is a plug-in that ingests data and tags into a CMDB from third-party sources of different domains like security, server, software or monitoring, and/or internet of things (IoT), and eliminates the need to write custom integrations while avoiding data quality issues such as duplicate CIs, misclassified data, and inconsistent attribute values. Once ingested, the tags can be stored in a configuration database or other tag store.

Mapping and visualization tools provided by the ServiceNow™ platform are configured to look for CIs that have a particular grouping of tags associated with an application service and add them to a map. If the CIs have relationships to other CIs, those are also added to the map via traversal rules, which facilitates creation of a useful visualization for an application service that provides insight into affected upstream resources when another resource has an issue, for example.

Since this application service mapping method uses tags, tags need to actually exist for the resources to be mapped. While the ServiceNow™ platform imports tags for virtualized environments when they exist (e.g., tags associated with virtual machines), many organizations struggle with incomplete or inconsistent tagging strategies. Significantly, physical devices inherently cannot have tags and, therefore, these CIs cannot be added to the maps. When organizations are using some percentage of devices not hosted in the cloud (i.e., on-prem, managed, or hybrid), these devices rarely have or even could have tags managed at the device level.

Thus, tag-based application service mapping and associated visualizations in PaaS environments often have limited utility and can yield inaccurate or incomplete maps. Other types of platforms and provided solutions also suffer from ineffective tag-based application service mapping that reduces the advantages for enterprises utilizing PaaS environments.

### BRIEF DESCRIPTION OF THE DRAWINGS

FIG. 1 is a block diagram of an exemplary network environment with a platform-as-a-service (PaaS) server device;

FIG. 2 is a block diagram of an exemplary PaaS server device;

FIG. 3 is a flowchart of an exemplary method for automated key-value tagging for visibility in PaaS environments;

FIG. 4 is an exemplary static tag generation interface;

FIG. 5 is an exemplary regular expression tag generation interface;

FIG. 6 is an exemplary script tag generation interface with execution window;

FIG. 7 is an exemplary preview window; and

FIG. 8 is an exemplary dependency map.

### DETAILED DESCRIPTION

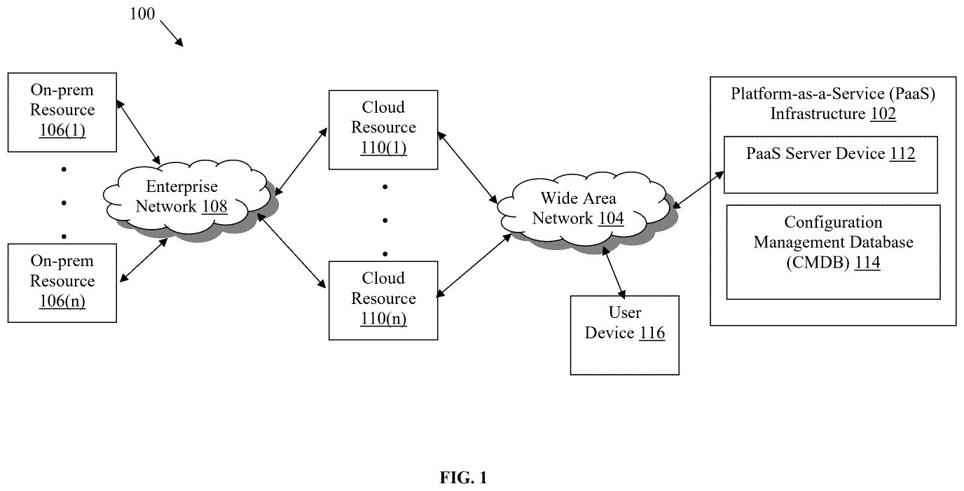

Referring to FIG. 1, an exemplary network environment 100 is illustrated that includes Platform-as-a-Service (PaaS) infrastructure 102 and a user device 116 coupled, via wide area network (WAN) 104, to an enterprise network 108 that includes on-prem resources 106(1)-106(n) (e.g., physical servers, routers, and switches), and cloud resources 110(1)-110(n) (e.g., virtual machines and storage buckets). The cloud resources 110(1)-110(n) are also coupled to the WAN 104 and, with the on-prem resources 106(1)-106(n), collectively comprise an IT infrastructure of an enterprise hosting of the enterprise network 108.

The network environment 100 also may include other network devices (e.g., one or more mid-servers), which are known in the art and thus will not be described herein. The technology described and illustrated by way of the examples herein provides a number of advantages including methods, non-transitory computer readable media, and PaaS server devices that facilitate automated key-value tagging for improved information technology (IT) infrastructure visibility for application services in PaaS environments.

In this example, the PaaS infrastructure 102 includes a PaaS server device 112 and a configuration management database (CMDB) 114, although the PaaS infrastructure 102 can include other types and/or another number of devices and/or components in other examples. For example, the PaaS infrastructure 102 could have a plurality of PaaS server devices hosting a plurality of platform instances for any number of enterprises.

One or more of the user device 116, cloud resources 110(1)-110(n), on-prem resources 106(1)-106(n), and/or PasS server device 112 can be implemented in hardware or software (e.g., within one or more other devices in the network environment 100). As one example, the PaaS server device 112 can be implemented in software or as a virtual server hosted by the same hardware device as the CMDB 114, and many other permutations and types of implementations can also be used in other examples.

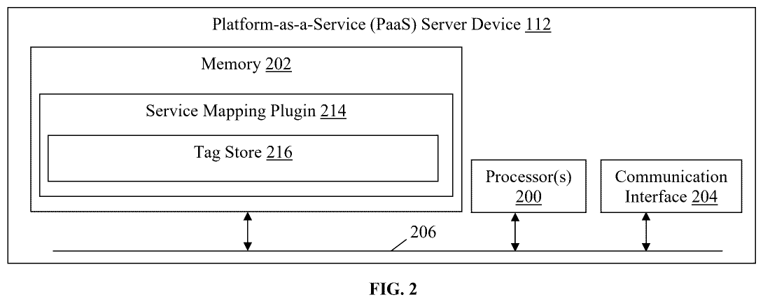

Referring to FIGS. 1-2, the PaaS server device 112 of the network environment 100 may perform any number of functions, including hosting platform instances, provided dashboards and portals for visibility into IT infrastructure, and/or facilitating application and/or service development and deployment, for example. The PaaS server device 112 in this example includes processor(s) 200, a memory 202, and a communication interface 204, which are coupled together by a bus 206, although the PaaS server device 112 can include other types or numbers of elements in other configurations.

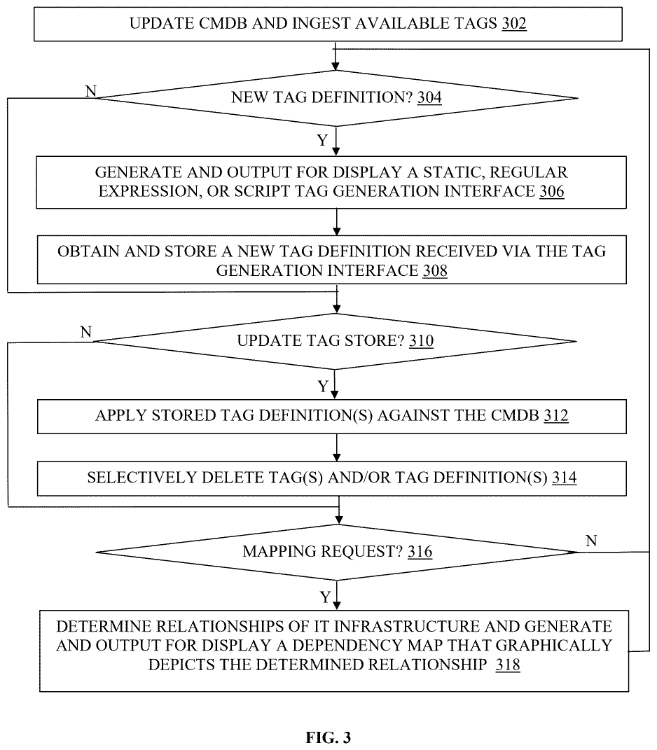

The processor(s) 200 of the PaaS server device 112 may execute programmed instructions stored in the memory 202 of the PaaS server device 112 for any number of the functions described and illustrated herein (e.g., with reference to FIGS. 3-8). The processor(s) 200 may include one or more central processing units or with one or more processing cores, for example, although other types of processor(s) can also be used.

The memory 202 of the PaaS server device 112 stores these instructions for one or more aspects of the present technology as described and illustrated herein, although some or all of the instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 200, can be used for the memory 202.

Accordingly, the memory 202 of the PaaS server device 112 can store one or more applications that can include computer executable instructions that, when executed by the PaaS server device 112, cause the PaaS server device 112 to perform actions, such as to transmit, receive, or otherwise process network messages and requests, for example, and to perform other actions described and illustrated below with reference to FIGS. 3-9. The application(s) can be implemented as components of other applications, operating system extensions, and/or plugins, for example.

Further, the application(s) may be operative in a cloud-based computing environment. The application(s) can be executed within or as virtual machine(s) or virtual server(s) that may be managed in a cloud-based computing environment. Also, the application(s), and even the PaaS server device 112 itself, may be located in virtual server(s) running in a cloud-based computing environment rather than being tied to one or more specific physical network computing devices. Also, the application(s) may be running in one or more virtual machines (VMs) executing on the PaaS server device 112. Additionally, in one or more examples of this technology, virtual machine(s) running on the PaaS server device 112 may be managed or supervised by a hypervisor.

In this particular example, the memory 202 of the PaaS server device 112 includes a service mapping plugin 214 with a tag store 216. The service mapping plugin 214 in this example is configured to determine relationships between configuration items (CIs) that may correspond with the IT infrastructure associated with an application service. To determine the relationships, the service mapping plugin 214 performs a tag-based service mapping that uses tags that are key/value pairs maintained in the tag store 216, as described and illustrated in more detail below.

While some tags can be ingested via application programming interfaces (APIs) (e.g., as provided by a host of the enterprise network 108 or a host of the cloud resources 110(1)-110(n)), other tags are established via an automated process that executes tag definitions that are generated as described and illustrated by way of the examples herein and are stored by the service mapping plugin 214. The tag store can be a database or any other data structure capable of maintaining key/value pairs of data. While the tag store 216 is illustrated in this example as separate from the CMDB 114, the tag store 216 in other examples can be part of (e.g., a table within) the CMDB 114 and/or linked to the CMDB 114 in other examples.

The CMDB 114 (e.g., a ServiceNow™M CMDB) stores configuration and other data for IT infrastructure associated with the enterprise associated with the enterprise network 108 to provide visibility and other utility for IT operations users. The CMDB 114 can be a Structured Query Language (SQL) or NoSQL database in some examples, and other types of databases and other repositories storing other types of data can also be used in other examples.

The communication interface 204 of the PaaS server device 112 operatively couples and communicates between the PaaS server device 112 and the enterprise network 108, and resources and devices coupled thereto, via the WAN 104, although other types or another number of communication networks or systems with other types or numbers of connections or configurations to other devices or elements can also be used. By way of example only, the WAN 104 can use TCP/IP over Ethernet and industry-standard protocols, although other types or numbers of protocols or communication networks can be used. The WAN 104 can include the Internet and can employ any suitable interface mechanisms and network communication technologies including, for example, Ethernet-based Packet Data Networks (PDNs).

While the PaaS server device 112 is illustrated in this example as including a single device, the PaaS server device 112 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the PaaS server device 112. Additionally, one or more of the devices that together comprise the PaaS server device 112 in other examples can be standalone devices or integrated with one or more other devices or apparatuses.

The user device 116 of the network environment 100 in this example includes any type of computing device that can exchange network data, such as mobile, desktop, laptop, or tablet computing devices, virtual machines (including cloud-based computers), or the like. The user device 116 includes a processor, a memory, and a communication interface, which are coupled together by a bus or other communication link (not illustrated), although other numbers or types of components could also be used.

The user device 116 may run interface applications, such as standard web browsers or standalone client applications, which may provide an interface to communicate with the PaaS server device 112 to request and obtain dependency maps for display. The user device 116 may further include a display device, such as a display screen or touchscreen, or an input device, such as a keyboard or mouse, for example (not illustrated).

Although the exemplary network environment 100 with the user device 116, cloud resources 110(1)-110(n), on-prem resources 106(1)-106(n), PaaS server device 112, enterprise network 108, and WAN 104 are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as the user device 116, cloud resources 110(1)-110(n), on-prem resources 106(1)-106(n), or PaaS server device 112, for example, may be configured to operate as virtual instances on the same physical machine. In other words, one or more of the user device 116, cloud resources 110(1)-110(n), on-prem resources 106(1)-106(n), or PaaS server device 112 may operate on the same physical device rather than as separate devices communicating through enterprise network 108 and/or WAN 104. Additionally, there may be more or fewer user devices, cloud resources, on-prem resources, or PaaS server devices, than illustrated in FIG. 1.

The examples of this technology may also be embodied as one or more non-transitory computer readable media having instructions stored thereon, such as in the memory 202, for one or more aspects of the present technology, as described and illustrated by way of the examples herein. The instructions in some examples include executable code that, when executed by one or more processors, such as the processor(s) 200, cause the processors to carry out steps necessary to implement the methods of the examples of this technology that are described and illustrated herein.

Referring to FIG. 3, a flowchart of an exemplary method for automated key-value tagging for visibility in PaaS environments is illustrated. In step 300 in this example, the PaaS server device 112 updates the CMDB 114 via a discovery process based on obtained configuration files (e.g., from a version control system (not shown) coupled to the enterprise network 108) and other data obtained via APIs associated with the on-prem resources 106(1)-106(n) and cloud resources 110(1)-110(n).

The PaaS server device 112 updates the CMDB 114 by populating record(s) of target table(s) corresponding to CIs based on data associated with identified fields. The PaaS server device 112 can identify fields that correspond with key, table, column, and/or row names in order to map configuration data. Based on the mapping, the PaaS server device 112 stores and/or replaces data with the appropriate file contents associated with the corresponding fields and/or generates relationships between records in the CMDB 114. The PaaS server device 112 also stores tags (i.e., key/value pairs) obtained via the APIs in the CMDB 114 and/or the tag store 216 to facilitate tag-based service mapping, as described and illustrated in detail below.

In step 304 in this example, the PaaS server device 112 executing the service mapping plugin 214 determines whether a request for a new tag definition has been received from the user device 116. The request can be received via a user interface provided by the service mapping plugin 214 to the user device 116, for example. A user of the user device 116 may initiate a request for a new tag definition to facilitate automated generation and storage of tags for an increased number of CIs corresponding to IT resources in the CMDB 114, including CIs for which tags were not ingested in step 302. If the PaaS server device 112 determines that a request for a new tag definition has been received, the Yes branch is taken to step 306.

In step 306, the PaaS server device 112 executing the service mapping plugin 214 generates and outputs to the requesting user device 116 for display a tag generation interface, which in the examples described and illustrated herein can be a static, regular expression, or script tag generation interface, although other types of tag generation interfaces can also be used in other examples.

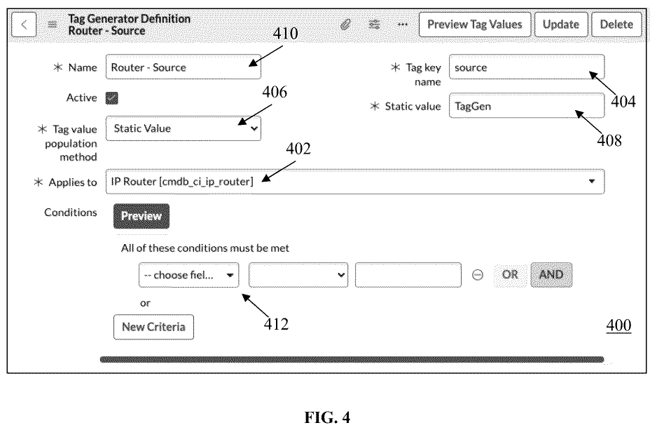

Referring to FIG. 4, an exemplary static tag generation interface 400 is illustrated. In this example, the static tag generation interface 400 includes a plurality of input fields including at least a table field 402, a tag key field 404, and a tag value population method field 406. The table field 402 is configured to facilitate input of a table or other structure within the CMDB 114 (i.e., the “IP Router” table in the example illustrated in FIG. 4) for which the new tag definition applies. The table field 402 can be a drop-down menu facilitating selection of tables identified in the CMDB 114, a text input field, or any other type of input field.

The tag key field 404 facilitates input of the tag key of the key/value pair corresponding to a tag generated according to the new tag definition generated using the static tag generation interface 400. Additionally, the tag value population method field 406 in this example facilitates selection by the user of the method by which the tag value (i.e., the value of the key/value pair corresponding to a tag generated according to the new tag definition generated using the static tag generation interface 400) is to be determined, which can be a static, regular expression, or script method, for example.

In this example in which the tag value population method is a static value, the static tag generation interface 400 further includes a tag value field 408, which facilitates input of a tag value (i.e., “TagGen” in this example) to be established for CIs to which the new tag definition applies. In this example, the static tag generation interface 400 includes option fields including a tag definition name field 410, which facilitates input by the user of a name for the tag definition (i.e., “Router Source” in this example), and condition input fields 412, which can be used to narrow the CIs to which the new tag definition is to apply, and other types and/or another number of fields can be used in other examples.

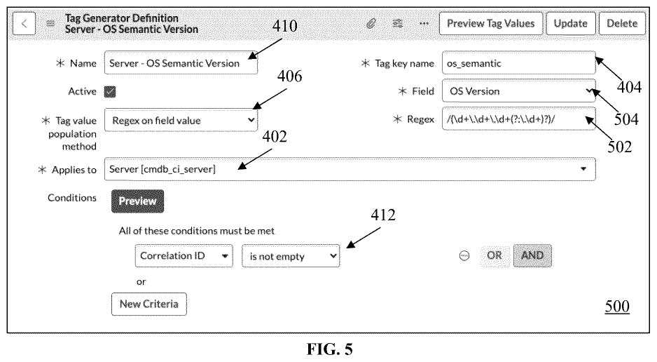

Referring now to FIG. 5, an exemplary regular expression tag generation interface 500 is illustrated. The regular expression tag generation interface 500 in this example includes the table field 402, tag key field 404, tag value population method field 406, tag definition name field 410, and condition input fields 412, as described above, along with a regular expression field 502 and a field selection field 504. The regular expression field 502 facilitates input by the user of a regular expression relating to fields (e.g., columns) of the table (i.e., the “Server” table in this example) of the CMDB 114 that is input via the table field 402.

To facilitate definition of the regular expression, the field selection field 504 can include a drop-down or other type of menu identifying the various fields in the CMDB 114 from which the user can select. In this particular example, the field of the table currently selected is the “OS version” field, which allows a user to define in the regular expression field a particular OS version to be used for, or included in, the tag value for each of the CIs in the “Server” table satisfying the regular expression (e.g., having an OS version of “15.1”). Thus, the user can generate the new tag definition to apply to the CIs in the “Server” table of the CMDB 114 that have a particular OS version such that the tag value is that OS version and the tag key is “os_semantic” in this example.

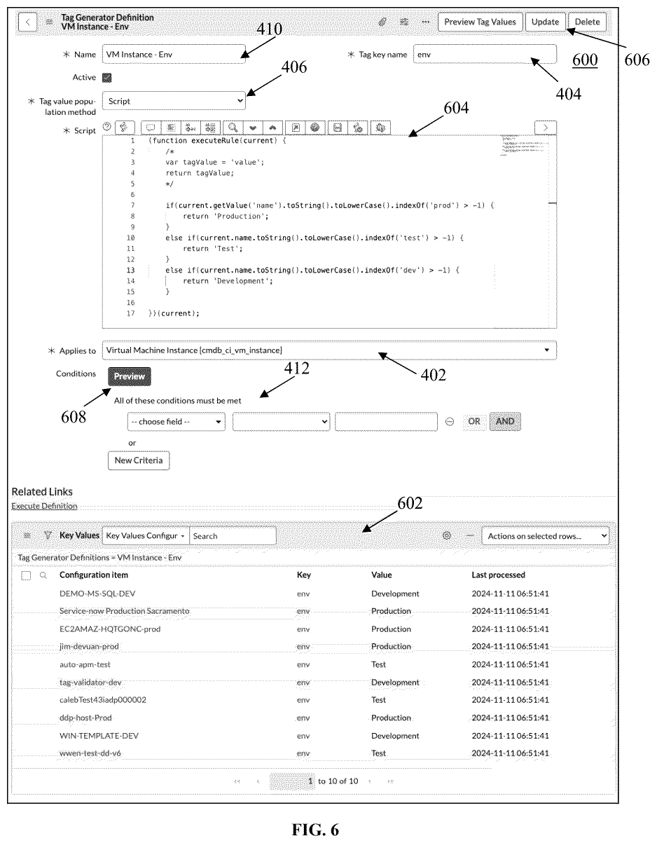

Referring to FIG. 6, an exemplary script tag generation interface 600 with execution window 602 is illustrated. The script tag generation interface 600 in this example includes the table field 402, tag key field 404, tag value population method field 406, tag definition name field 410, and condition input fields 412, as described above, along with a script field 604. The script field 604 facilitates input by the user of a script to be executed against portions of the CIs in the CMDB 114, which returns a string that is to be used for the tag value. In this example, the tag key is “emv” for each CI in the “Virtual Machine Instance” table of the CMDB 114 and the tag value for each of those CIs is “Production,” “Test,” or “Development” depending on satisfaction of a condition defined in the script input via the script field 604.

Referring back to FIG. 3, in step 308, the PaaS server device 112 executing the service mapping plugin 214 obtains and stores a new tag definition received via the tag generation interface generated and output in step 306. The new tag definition includes an indication of a table, a tag key, and a tag value population method (e.g., “static,” “regular expression,” or “script”). For new tag definitions including the “static” tag value population method, the stored new tag definition includes a static tag value (e.g., as obtained via the tag value field 408). For new tag definitions including the “regular expression” tag value population method, the stored new tag definition includes a regular expression (e.g., as obtained via the regular expression field 502). Additionally, for new tag definitions including the “script” tag value population method, the stored new tag definition includes a script (e.g., as obtained via the script field 604).

Optionally, the new tag definition can be obtained and stored in response to selection by the user of the user device 116 of a link or button. For example, referring back to FIG. 6, the update button 606 can be selected to submit the new tag definition to storage, which can be the memory 202, tag store 216, or another data structure or storage location, for example. Also optionally, the tag generation interface can be configured to selectively provide a preview of the tag key/value pair that would be generated for corresponding CIs if the new tag definition was applied against the CMDB 114.

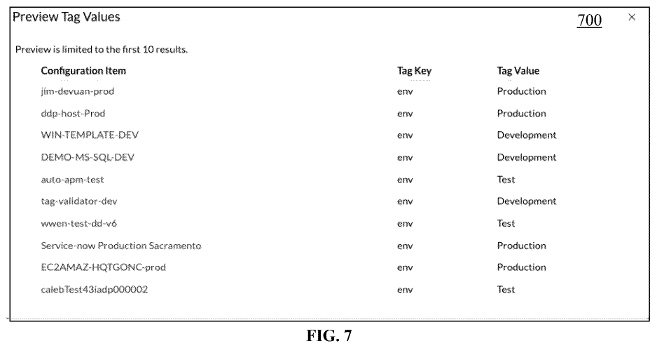

Referring to FIG. 7, an exemplary preview window 700 is illustrated. In this example, the preview window 700 can be generated in response to selection by the user of a link or button, such as the preview button 608 of the script tag generation interface 600. To generate the preview window 700, the script tag generation interface 600 in this example is configured to apply the new tag definition, as defined based on the current field values input to the script tag generation interface 600, against the identified table of the CMDB 114 to identify CIs and determine the corresponding tag values. The tag values are determined without storing the tag key/value pairs in the tag store 216 or storing, or updating the previously-stored, tag definition.

Referring back to FIG. 3, subsequent to obtaining and storing the new tag definition in step 308, or if the PaaS server device 112 determines in step 304 that a request for a new tag definition has not been received and the No branch is taken, then the PaaS server device 112 proceeds to step 310. In step 310, the PaaS server device 112 executing the service mapping plugin 214 determines whether one or more stored tag definitions should be applied to update the tag store 216. In some examples, the PaaS server device 112 automatically updates the tag store 216 whenever a new tag definition is established or a previously-stored tag definition is updated (e.g., via the update button 606 of FIG. 6). In other examples, the PaaS server device 112 can be configured to apply each of the stored tag definition(s) periodically in order to update the tag store 216. Other triggers for updating the tag store 216 can also be used in other examples. If the PaaS server device 112 determines that the tag store should be updated, then the Yes branch is taken to step 312.

In step 312, the PaaS server device 112 executing the service mapping plugin 214 applies at least the new tag definition obtained and stored in step 308 against the table of the CMDB 114 identified in the new tag definition to identify CI(s) for which a tag should be generated and associated in the tag store 216. Thus, in this example, the PaaS server device 112 stores or updates entries or records corresponding to the configuration item(s) in the tag store 216 to include the tag key and the tag value determined based on the tag value population method (e.g., based on a static tag value, application of a regular expression, or execution of a script). The PaaS server device 112 performs the same steps as described above with respect to the preview window 700 except that the new tag definition is stored or updated, and the generated tag values are also stored or updated in the tag store 216.

Optionally, the PaaS server device 112 can be configured to display the tags that were generated as a result of the application of the new tag definition, such as via the execution window 602 of FIG. 6. In this example, the execution window 602 illustrates the CIs for which the corresponding tag key and tag value were generated along with a timestamp, although other information can also be included in the execution window 602 in other examples.

Referring back to FIG. 3, in step 314, the PaaS server device 112 executing the service mapping plugin 214 selectively deletes tag(s) and/or tag definition(s) from the tag store 216 and/or other storage data structures or locations. In some examples, the deletion is based on an updating of a tag definition or updating of a tag value as a result of an updated tag definition, for example. Thus, in these examples, the cleanup is performed during the application of the tag definition(s) in step 312. In other examples, the PaaS server device 112 is configured to periodically apply stored cleanup parameters to the tag store 216 to thereby delete tag keys and tag values from entries of the tag store 216. In these examples, the deletion is a form of periodic cleanup or garbage collection that is user-configurable.

For example, a user can define a time period in the cleanup parameters such that a tag definition that is inactive of stale for a time period exceeding the defined time period is automatically deleted. In one specific example, tag definitions can be deleted when a valid tag value has not been found by the PaaS server device 112 for a CI in the trailing thirty day period as defined in the cleanup parameters, for example. In some examples, the PaaS server device 112 can be configured to generate and provide a settings interface to the user device 116 that facilitates input and storage of the cleanup parameters, although other methods for establishing the cleanup parameters can also be used in other examples.

Subsequent to deleting any tag(s) and/or tag definition(s) in the current iteration, or if the PaaS server device 112 determines in step 312 that is should not update the tag store 216 and the No branch is taken, then the PaaS server device 112 proceeds to step 316. In step 316, the PaaS server device 112 executing the service mapping plugin 214 determines whether a mapping request has been received. A mapping request can be submitted by a user of the user device 116 via a visualization interface provided to the user device 116 by the PaaS server device 112, for example. If the PaaS server device 112 determines that a mapping request has been received, then the Yes branch is taken to step 318.

In step 318, the PaaS server device 112 executing the service mapping plugin 214 determines a relationship of at least a portion of the IT infrastructure or CIs associated with an application service based on the stored tags in the tag store 216. The stored tags could have been ingested in step 300 and/or could have been automatically generated, as described and illustrated in detail above. The application service for which the relationships are determined can be identified in the received mapping request.

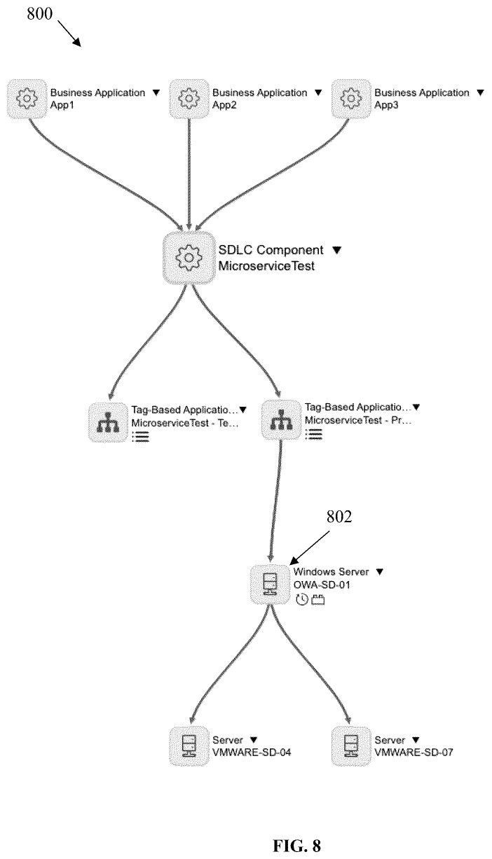

Additionally, in step 318, the PaaS server device 112 generates, and outputs for display via the requesting user device 116, a dependency map for the application service that graphically depicts the determined relationships. Referring to FIG. 8, an exemplary dependency map 800 is illustrated. The dependency map 800 provides a graphical depiction of the organization of the associated IT infrastructure associated with an application service.

In particular, there are three business applications in this example associated with the test microservice Software Development Life Cycle (SDLC) Component, which is associated with two tag-based application services in test and production environments, with the production environment associated with a Windows™M server associated with two software-defined virtual servers. The graphical dependency map 800 could be generated by the PaaS server device 112 hosting a platform instance associated with the enterprise upon request from the user device 116 to provide visibility into the IT infrastructure. In this particular example, without the technology described and illustrated by way of the examples herein, it may not have been possible to include the Window Server 802, for example, in the dependency map 800 because it is a physical or hardware device for which a tag may not have been ingested.

Accordingly, as described and illustrated by way of the examples herein, this technology advantageously facilitates automated tag-based service mapping for enterprise platform instances. The disclosed technology enables automated tagging for CIs that lack native tags and automatically creates tags in the same tag store 216 that is utilized for tag-based service mapping based on user-configurable tag definitions. Thereby, this technology more efficiently and effectively maintains tags in PaaS environments in a more accurate, comprehensive, and automated manner to facilitate improved downstream utility of the CMDB 114 and improved visibility into enterprise IT infrastructure, for example.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

1. A method for automated configuration item key-value tagging for mapping tag-based application service infrastructure in platform-as-a-service (PaaS) environments, the method implemented by a PaaS server device and comprising:
automatically generating and outputting to a user device for display a tag generation graphical user interface in response to a request received from the user device for a new tag definition, wherein the request is received via one or more communication networks including an enterprise network associated with an enterprise;
storing in a storage device the new tag definition received via the tag generation graphical user interface and from the user device, wherein the new tag definition comprises a first indication of a table of a configuration management database (CMDB), a tag key, a second indication of a field of the table, and a regular expression;
applying the regular expression to a field value of one or more records of the table of to identify one or more configuration items, wherein the CMDB is associated with a platform instance associated with the enterprise and hosted within a PaaS environment, the configuration items correspond to information technology infrastructure (IT) associated with one of a plurality of application services within the platform instance, and at least one of the configuration items corresponds to a physical device of the IT infrastructure; and
updating one or more entries, corresponding to the configuration items, in a tag store, maintained by a service mapping plugin executed by the PaaS server device, to include a key-value pair comprising the tag key and a tag value comprising the field value, wherein the configuration items are mapped to the IT infrastructure of the one of the application services based on the key-value pair.

2. The method of claim 1, wherein the tag store comprises a table, database, or other data structure within or linked to the CMDB.

3-5. (canceled)

6. The method of claim 1, further comprising periodically applying stored cleanup parameters to the tag store to thereby delete the tag key and the tag value from one or more of the entries.

7. A non-transitory computer readable medium having stored thereon instructions for automated configuration item key-value tagging for mapping tag-based application service infrastructure in platform-as-a-service (PaaS) environments comprising executable code that, when executed by one or more processors, causes the processors to:
automatically generate and output to a user device for display a tag generation graphical user interface in response to a request received from the user device for a new tag definition, wherein the request is received via one or more communication networks including an enterprise network associated with an enterprise;
store in a storage device the new tag definition received via the tag generation graphical user interface and from the user device, wherein the new tag definition comprises a first indication of a table of a configuration management database (CMDB), a tag key, and a script;
execute the script against the table to identify one or more configuration items, wherein the CMDB is associated with a platform instance associated with the enterprise and hosted within a PaaS environment, the configuration items correspond to information technology infrastructure (IT) associated with one of a plurality of application services within the platform instance, and at least one of the configuration items corresponds to a physical device of the IT infrastructure; and
update one or more entries, corresponding to the configuration items. in a tag store, maintained by a service mapping plugin executed by the PaaS server device, to include a key-value pair comprising the tag key and a tag value comprising a string returned by the script based on the execution, wherein the configuration items are mapped to the IT infrastructure of the one of the application services based on the key-value pair.

8. The non-transitory computer readable medium of claim 7, wherein the tag store comprises a table, database, or other data structure within or linked to the CMDB.

9-11. (canceled)

12. The non-transitory computer readable medium of claim 7, wherein the executable code, when executed by the processors, further causes the processors to periodically apply stored cleanup parameters to the tag store to thereby delete the tag key and the tag value from one or more of the entries.

13. A platform-as-a-service (PaaS) server device, comprising memory comprising instructions stored thereon, for automated configuration item key-value tagging for mapping tag-based application service infrastructure in platform-as-a-service (PaaS) environments, and one or more processors configured to execute the stored instructions to:
automatically generate and output to a user device for display a tag generation graphical user interface in response to a request received from the user device for a new tag definition, wherein the request is received via one or more communication networks including an enterprise network associated with an enterprise;
store in a storage device the new tag definition received via the tag generation graphical user interface and the user device, wherein the new tag definition comprises a first indication of a table of a configuration management database (CMDB), a tag key, and a tag value;
apply the new tag definition against the table to identify one or more configuration items, wherein the CMDB is associated with a platform instance associated with the enterprise and hosted within a PaaS environment, the configuration items correspond to information technology infrastructure (IT) associated with one of a plurality of application services within the platform instance, and at least one of the configuration items corresponds to a physical device of the IT infrastructure; and
update one or more entries, corresponding to the configuration items, in a tag store, maintained by a service mapping plugin executed by the PaaS server device, to include a key-value pair comprising the tag key and the tag value, wherein the configuration items are mapped to the IT infrastructure of the one of the application services based on the key-value pair.

14. The PaaS server device of claim 13, wherein the tag store comprises a table, database, or other data structure within or linked to the CMDB.

15-17. (canceled)

18. The PaaS server device of claim 13, wherein the processors are further configured to execute the stored instructions to periodically apply stored cleanup parameters to the tag store to thereby delete the tag key and the tag value from one or more of the entries.

19. The PaaS server device of claim 13, wherein the processors are further configured to execute the stored instructions to, in response to user selection of a preview button of the tag generation graphical user interface:
obtain the new tag definition, and apply the new tag definition against the table of the CMDB to identify the configuration items, before storing the new tag definition; and
generate, and output for display via the user device, a preview window graphical user interface comprising an indication of at least the configuration items, the tag key, and the tag value.

20. The PaaS server device of claim 13, wherein processors are further configured to execute the stored instructions to:
obtain a configuration file for the application service via a wide area network and from a version control system communicably coupled to the enterprise network;
determine a relationship of at least a portion of the IT infrastructure based on the configuration file and contents of the tag store; and
generate, and output for display via the user device, a dependency map for the application service that graphically depicts the determined relationship.

21. The method of claim 1, further comprising, in response to user selection of a preview button of the tag generation graphical user interface:
obtaining the new tag definition, and apply the new tag definition against the table of the CMDB to identify the configuration items, before storing the new tag definition; and
generating, and outputting for display via the user device, a preview window graphical user interface comprising an indication of at least the configuration items, the tag key, and the tag value.

22. The method of claim 1, further comprising:
obtaining a configuration file for the application service via a wide area network and from a version control system communicably coupled to the enterprise network;
determining a relationship of at least a portion of the IT infrastructure based on the configuration file and contents of the tag store; and
generating, and outputting for display via the user device, a dependency map for the application service that graphically depicts the determined relationship.

23. The non-transitory computer readable medium of claim 7, wherein the executable code, when executed by the processors, further causes the processors to, in response to user selection of a preview button of the tag generation graphical user interface:
obtain the new tag definition, and apply the new tag definition against the table of the CMDB to identify the configuration items, before storing the new tag definition; and
generate, and output for display via the user device, a preview window graphical user interface comprising an indication of at least the configuration items, the tag key, and the tag value.

24. The non-transitory computer readable medium of claim 7, wherein the executable code, when executed by the processors, further causes the processors to:
obtain a configuration file for the application service via a wide area network and from a version control system communicably coupled to the enterprise network;
determine a relationship of at least a portion of the IT infrastructure based on the configuration file and contents of the tag store; and
generate, and output for display via the user device, a dependency map for the application service that graphically depicts the determined relationship.
